(19) United States
(12) Patent Application Publication
(10) Pub. No.: US 2017/0222534 A1
(43) Pub. Date: Aug. 3, 2017

(54) DUAL DIAMAGNETIC LINEAR RESONANT ACTUATOR WITH MAGNETIC ROLLER BALLS

(71) Applicant: TOPRAY MEMS INC., Hsinchu City (TW)

(72) Inventors: Chin-Sung LIU, Hsinchu City (TW); Hsiao-Ming CHIEN, Hsinchu City (TW)

(73) Assignee: TOPRAY MEMS INC., Hsinchu City (TW)

(21) Appl. No.: 15/159,342

(22) Filed: May 19, 2016

(30) Foreign Application Priority Data
Jan. 29, 2016 (TW) 105201482

(51) Int. Cl. H02K 33/16; H02K 5/173

(52) U.S. Cl. CPC H02K 33/16; H02K 5/173

(57) ABSTRACT

A dual diamagnetic linear resonant actuator with magnetic roller-balls is disclosed, comprising: a first magnetic induction element, a magnet set, a coil, an inner and an outer sliding track sets. The magnet set comprises four magnets. The N poles of first and second magnets, S poles of third and fourth magnets press respectively against the first, second, third and fourth side of the first magnet induction element. The inner sliding track set includes base bodies, disposed at first and second magnets and forming inner side tracks, and magnetic roller-balls, disposed at inner side tracks with center aligned with S pole of first and second magnets. The outer sliding track set includes outer side tracks, with the coil fixed to the outer side tracks, which contact the magnetic roller-balls. As such, the friction of the magnetic roller-balls with the inner and outer side tracks improves the steady state response efficiency.

### CROSS-REFERENCE TO RELATED APPLICATION

The present application is based on, and claims priority form, Taiwan Patent Application No. 105201482, filed Jan. 29, 2016, the disclosure of which is hereby incorporated by reference herein in its entirety.

### TECHNICAL FIELD

The technical field generally relates to a linear resonant actuator, and in particular, to a dual diamagnetic linear resonant actuator with magnetic roller balls based on resonance generated by electromagnetic effect.

### BACKGROUND

The resonance of portable electronic devices, such as, mobile phones or tablet PCs, is generated by a resonant device inside the portable electronic device. The earlier resonant device often relies on eccentric rotating mass (ERM) vibration motor to provide resonance.

Recently, a trend is forming by replacing the ERM vibration motor with a linear resonant actuator to serve as the resonant device. The reason is that the linear resonant actuator utilizes the Lorentz force generated by the electromagnetic effect to drive a movable part for simple harmonic motion to produce resonance, which is fast in response and low in power-consumption.

The problem of the known linear resonant actuator is that the friction between the inner and outer sliding tracks is high so that the steady-state response of the movable part is low in efficiency, resulting in the reduced touch application, resonance effect, shortened lifespan, and noise.

Hence, it is desirable to provide a linear resonant actuator, with appropriate friction between the inner and outer sliding tracks to improve the steady-state response efficiency to overcome the aforementioned shortcomings of the known techniques.

### SUMMARY

The primary object of the present invention is to provide a dual diamagnetic linear resonant actuator with magnetic roller-balls, so that the steady-state response efficiency of the movable part is improved by the magnetic roller-balls and appropriate friction provided by the inner and outer sliding tracks.

To achieve the aforementioned objects, the present invention provides a dual diamagnetic linear resonant actuator with magnetic roller-balls, comprising: a first magnetic induction element, a magnet set, a coil, an inner sliding track set and an outer sliding track set.

The first magnetic induction element has a first end, a second end, a first side, a second side, a third side and a fourth side, wherein the first side and the second side are opposite to each other, while the third side and the fourth side are opposite to each other.

The magnet set comprises a first magnet, a second magnet, a third magnet, and a fourth magnet. The first magnet has an S pole and an N pole. The N pole of the first magnet presses against the first side of the first magnetic induction element. The second magnet has an S pole and an N pole. The N pole of the second magnet presses against the second side of the first magnetic induction element. The third magnet has an S pole and an N pole. The S pole of the third magnet presses against the third side of the first magnetic induction element. The fourth magnet has an S pole and an N pole. The S pole of the fourth magnet presses against the fourth side of the first magnetic induction element.

The coil surrounds the first magnetic induction element, the third magnet and the fourth magnet, and maintains a distance from the first end and the second end of the first magnetic induction element, and from the N pole of the third magnet and the N pole of the fourth magnet.

The inner sliding track set includes two base bodies and a plurality of magnetic roller-balls. The two base bodies are disposed respectively at the first magnet and the second magnet, and form respectively a plurality of inner side tracks. The plurality of magnetic roller-balls is roll-ably disposed on the plurality of inner side tracks, and the center of the ball is aligned with the S poles of the first and the second magnets.

The outer sliding track set includes two outer side tracks. The coil is fixed to the two outer side tracks. The plurality of magnetic roller-balls contacts respectively the two outer side tracks.

According to a preferred embodiment, each base body includes a top wall, a bottom wall, a connection wall and four inner side tracks. The connection wall connects the top wall and the bottom wall, and forms a clamping space with the top wall and the bottom wall. The first magnet and the second magnet are clamped respectively by the two base bodies in the respective clamping spaces, wherein the two inner side tracks are disposed on two sides of the top wall and defined as the two upper inner tracks, and the remaining two inner side tracks are disposed on the two sides of the bottom wall and defined as the two lower inner tracks. The inner sliding track set includes eight magnetic roller-balls, and the eight magnetic roller-balls are disposed respectively on the four upper inner tracks and the four lower inner tracks.

According to a preferred embodiment, the upper inner tracks forms respectively an upper ball trench, and the lower inner tracks form respectively a lower ball trench. A side of the upper ball trench facing the two outer sliding tracks forms respectively an upper opening, and a side of the lower ball trench facing the two outer side tracks forms respectively a lower opening. The plurality of magnetic roller-balls is roll-ably disposed on the upper and the lower ball trenches and protrudes beyond the upper and the lower openings.

According to a preferred embodiment, the length direction of the upper and lower ball trenches is parallel to the length direction of the two outer side tracks. Each of the upper and lower ball trenches includes two stop walls. The two stop walls of the upper and lower ball trenches protrude from the bottom wall of the upper and lower ball trenches, and the magnetic roller-balls are located between the two stop walls of the upper and lower ball trenches.

According to a preferred embodiment, the two stop walls of the upper and lower ball trenches are located at the two ends along the length direction of the upper and lower ball trenches.

According to a preferred embodiment, the distance between the two stop walls of the upper and lower ball trenches is greater than the diameter of the magnetic roller-balls.

According to a preferred embodiment, the connection between the inner wall and the bottom wall of the upper and lower ball trenches has an arc-shaped surface.

According to a preferred embodiment, the bottom of the magnetic roller-balls disposed on the upper ball trenches is at a lower level than the top of the first and the second magnets; and the top of the magnetic roller-balls disposed on the lower ball trenches is at a higher level than the bottom of the first and the second magnets.

According to a preferred embodiment, each upper inner track includes an upper connection portion, an upper bending portion and an upper extension portion. The plurality of upper connection portions is connected to the two sides of the top wall of the two base bodies and extends upwards; the plurality of upper bending portions is connected to the upper connection portions and the upper extension portions; and the plurality of upper extension portions extends laterally downwards; the plurality of upper ball trenches are disposed in a concave manner at the end of the plurality of upper extension portions. Each lower inner track includes a lower connection portion, a lower bending portion and a lower extension portion. The plurality of lower connection portions is connected to the two sides of the bottom wall of the two base bodies and extends downwards; the plurality of lower bending portions is connected to the lower connection portions and the lower extension portions; and the plurality of lower extension portions extends laterally upwards; the plurality of lower ball trenches are disposed in a concave manner at the end of the plurality of lower extension portions.

According to a preferred embodiment, the dual diamagnetic linear resonant actuator with magnetic roller-balls further comprises two second magnetic induction elements and two third magnetic induction elements, the two second magnetic induction elements are disposed at the coil, located respectively above and below the first magnet, and maintain a distance from the first magnet respectively; the two third magnetic induction elements are disposed at the coil, located respectively above and below the second magnet, and maintain a distance from the second magnet respectively; wherein the two ends of the two second magnetic induction elements along the length direction are defined as a first end and a second end, the second ends of the two second magnetic induction elements are aligned with the end of the S pole of the first magnet; the two ends of the two third magnetic induction elements along the length direction are defined as a first end and a second end, and the second ends of the two third magnetic induction elements are aligned with the end of the S pole of the second magnet.

The advantage of the present invention lies in that the magnetic roller-balls have high magnetic induction rate. According to the orientation of the magnetic lines, the centers of the magnetic roller-balls are aligned with the ends of the S poles of the first magnet and the second magnet. As such, when the movable part is driven by either the Lorentz force or the magnetic restoration force to move, the proper friction force is provided by the magnetic roller-balls with the upper and lower ball trench and the two outer side tracks so as to improve the steady state response efficiency of the movable part and further improve the touch and resonance as well as improve lifespan and reduce the noise.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a dual diamagnetic linear resonant actuator with magnetic roller-balls in accordance with an exemplary embodiment;

FIG. 2 shows a schematic view of the dual diamagnetic linear resonant actuator with magnetic roller-balls excluding the outer sliding track set in accordance with an exemplary embodiment;

FIG. 3 shows a dissected view of the dual diamagnetic linear resonant actuator with magnetic roller-balls excluding the outer sliding track set in accordance with an exemplary embodiment;

FIG. 4 shows a schematic view of the magnetic line distribution of the dual diamagnetic linear resonant actuator with magnetic roller-balls in accordance with an exemplary embodiment;

FIG. 5A shows a dissected view of the movable part of the dual diamagnetic linear resonant actuator with magnetic roller-balls moving towards left with respect to the fixed part in accordance with an exemplary embodiment;

FIG. 5B shows a dissected view of the movable part of the dual diamagnetic linear resonant actuator with magnetic roller-balls moving towards right with respect to the fixed part in accordance with an exemplary embodiment; and

FIG. 5C shows a dissected view of the movable part of the dual diamagnetic linear resonant actuator with magnetic roller-balls automatically restoring to original position by the magnetic restoration force after the coil cutting off power in accordance with an exemplary embodiment.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

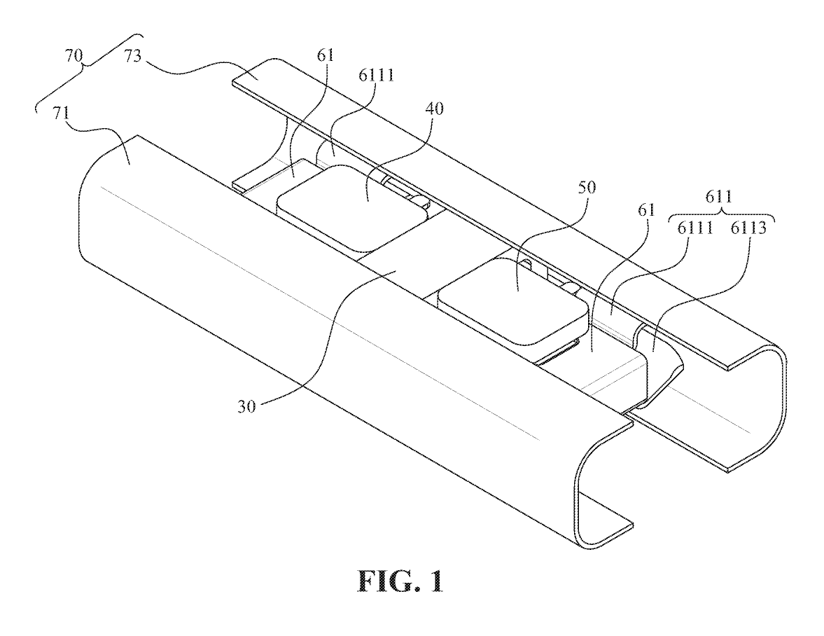

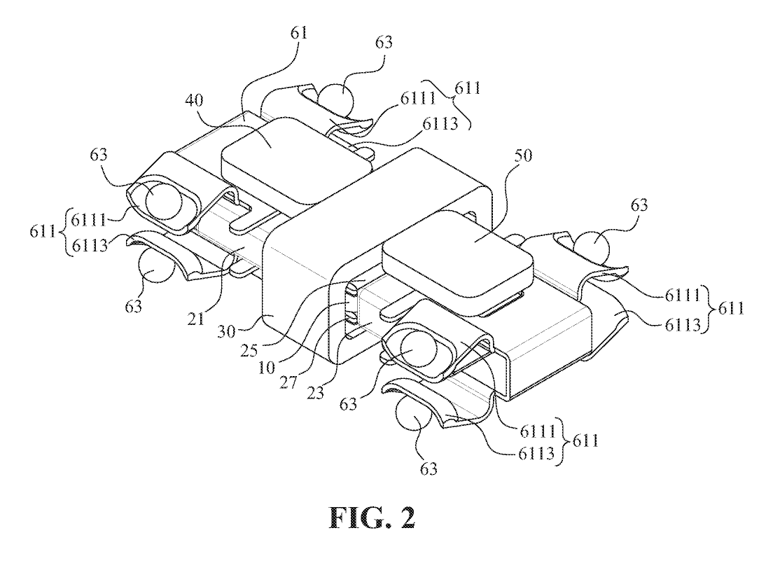

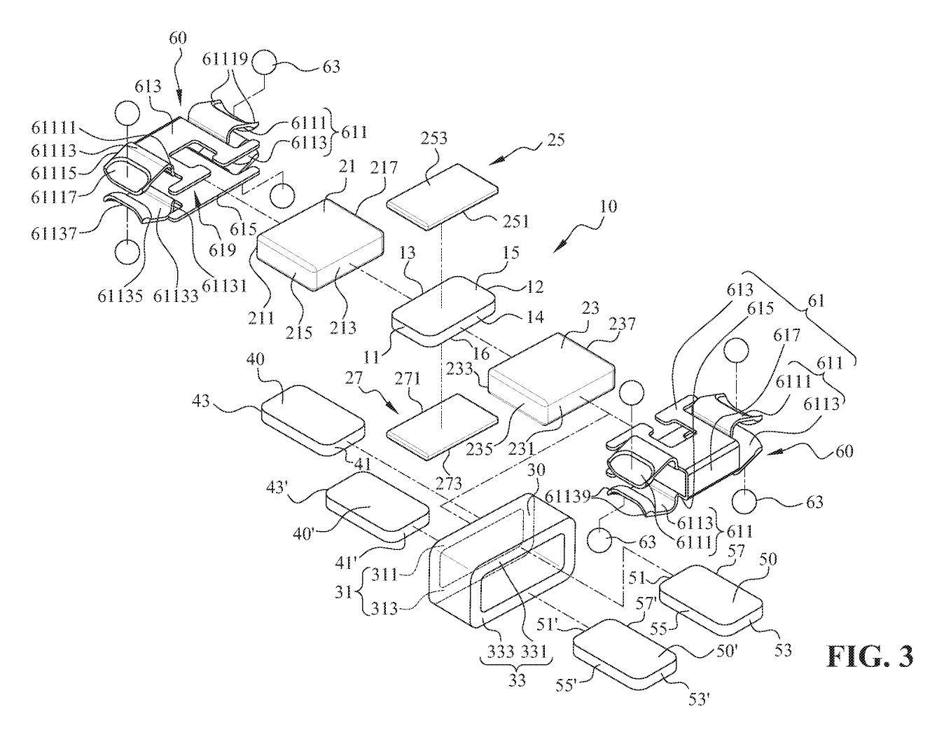

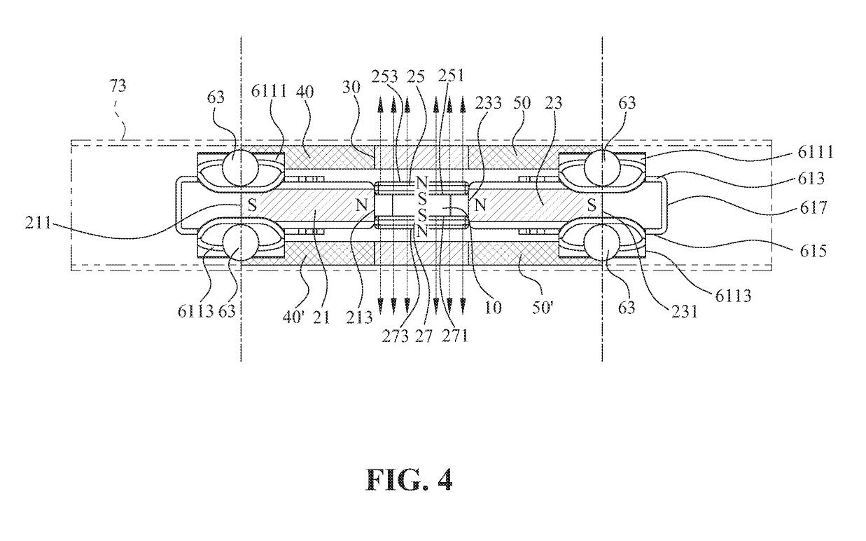

Refer to FIGS. 1-4. FIG. 1 shows a schematic view of a dual diamagnetic linear resonant actuator with magnetic roller-balls in accordance with an exemplary embodiment; FIG. 2 shows a schematic view of the dual diamagnetic linear resonant actuator with magnetic roller-balls excluding the outer sliding track set in accordance with an exemplary embodiment; FIG. 3 shows a dissected view of the dual diamagnetic linear resonant actuator with magnetic roller-balls excluding the outer sliding track set in accordance with an exemplary embodiment; and FIG. 4 shows a schematic view of the magnetic line distribution of the dual diamagnetic linear resonant actuator with magnetic roller-balls in accordance with an exemplary embodiment. The present invention provides a dual diamagnetic linear resonant actuator with magnetic roller-balls, comprising: a first magnetic induction element 10, a magnet set 20, a coil 30, two second magnetic induction elements 40, 40′, two third magnetic induction elements 50, 50′, an inner sliding track set 60 and an outer sliding track set 70.

The first magnetic induction element 10 has a first end 11, a second end 12, a first side 13, a second side 14, a third side 15 and a fourth side 16, wherein the first side 13 and the second side 14 are opposite to each other, while the third side 15 and the fourth side 16 are opposite to each other. In the present embodiment, the first magnetic induction element 10 is a cuboid. The distance between the first end 11 and the second end 12 is the length of the cuboid. The distance between the first side 13 and the second side 14 is the width of the cuboid. The distance between the third side 15 and the fourth side 16 is the height (i.e., thickness).

The magnet set 20 comprises a first magnet 21, a second magnet 23, a third magnet 25, and a fourth magnet 27. The first magnet 21 has an S pole 211 and an N pole 213. The N pole 213 of the first magnet 211 presses against the first side 13 of the first magnet induction element 10. The second magnet 23 has an S pole 231 and an N pole 233. The N pole 231 of the second magnet 23 presses against the second side 14 of the first magnet induction element 10. The third magnet 25 has an S pole 251 and an N pole 253. The S pole 251 of the third magnet 25 presses against the third side 15 of the first magnet induction element 10. The fourth magnet 27 has an S pole 271 and an N pole 273. The S pole 271 of the fourth magnet 27 presses against the fourth side 16 of the first magnet induction element 10. In the present embodiment, the thickness of the first magnetic induction element 10 is greater than the thickness of the third and the fourth magnets 25, 27. Preferably, the first and the second magnets 21, 23 are cuboids of the same size, and the third and the fourth magnets 25, 27 are cuboids of the same size. In other words, the first and the second magnets 21, 23 have the same length, width and height (i.e., thickness), and the third and the fourth magnets 25, 27 have the same length, width and height (i.e., thickness). Wherein, the two ends of the first magnet 21 along the width are the S pole 211 and the N pole 213. The two sides along the length of the first magnet 21 are defined as the first side 215 and the second side 217. The two ends of the second magnet 23 along the width are the S pole 231 and the N pole 233. The two sides along the length of the second magnet 23 are defined as the first side 235 and the second side 237. Preferably, the thickness of the first magnet 21 and the second magnet 23 is the same as the combined thickness of the first magnetic induction element 10, the third magnet 25 and the fourth magnet 27. Preferably, the first, second, third and fourth magnets 21, 23, 25, 27 have the same length as the first magnetic induction element 10; the third and the fourth magnets 25, 27 have the same width as the first magnetic induction element 10; the center of the N pole 213, 233 of the first and the second magnets 21, 23 presses respectively against the first side 13 and the second side 14 of the first magnetic induction element 10; the part of the N pole 213, 233 of the first and the second magnets 21, 23 near the top and the bottom of the first and the second magnets 21, 23 presses against the two sides of the third and the fourth magnets 25, 27.

The coil 30 surrounds the first magnetic induction element 10, the third magnet 25 and the fourth magnet 27, and respectively maintains a distance from the first end 11 and the second end 12 of the first magnetic induction element 10, and from the N pole 253 of the third magnet 25 and the N pole 273 of the fourth magnet 27. Wherein, the side of the coil 30 corresponding to the first magnet 21 is defined as a first side part 31. The first side part 31 of the coil 30 comprises an upper part 311 and a lower part 313; the side of the coil 30 corresponding to the second magnet 23 is defined as a second side part 33. The second side part 33 of the coil 30 comprises an upper part 331 and a lower part 333.

The two second magnetic induction elements 40, 40′ are disposed at the coil 30, located respectively above and below the first magnet 21 and maintain respectively a distance from the first magnet 21. Preferably, two second magnetic induction elements 40, 40′ are disposed respectively at the upper part 311 and the lower part 313 of the first side part 31 of the coil 30. Preferably, the two ends of the two second magnetic induction elements 40, 40′ along the length are defined as a first end 41, 41′ and a second end 43, 43′, respectively. The two sides of the two second magnetic induction elements 40, 40′ are defined as a first side 45, 45′ and a second side 47, 47′, respectively. The first ends 41, 41′ of the two second magnetic induction elements 40, 40′ are disposed respectively at the upper part 311 and the lower part 313 of the first side part 31 of the coil 30. Wherein, the length of the two second magnetic induction elements 40, 40′ is the same as the width of the first magnet 21. In other words, the second ends 43, 43′ of the second magnetic induction elements 40, 40′ are aligned to the end of the S pole 211 of the first magnet 21. The width of the two second magnetic induction elements 40, 40′ is less than the length of the first magnet 21. Preferably, the first ends 41, 41′ of the two second magnetic induction elements 40, 40′ are disposed respectively at the center of the upper part 311 and the center of the lower part 313 of the first side part 31 of the coil 30. In other embodiments, it is also allowable that the length of the two second magnetic induction elements 40, 40′ is the same as the width of the first magnet 21, and the width of the two second magnetic induction elements 40, 40′ is the same as the length of the first magnet 21. In other embodiments, the resettable dual diamagnetic linear resonant actuator may also comprise only one second magnetic induction element 40.

The two third magnetic induction elements 50, 50′ are disposed at the coil 30, located respectively above and below the second magnet 23, and maintain respectively a distance from the second magnet 23. Preferably, the two third magnetic induction elements 50, 50′ are disposed respectively at the upper part 331 and the lower part 333 of the second side part 33 of the coil 30. Preferably, the two ends of the two third magnetic induction elements 50, 50′ along the length are defined as a first end 51, 51′ and a second end 53, 53′, respectively. The two sides of the two third magnetic induction elements 50, 50′ are defined as a first side 55, 55′ and a second side 57, 57′, respectively. The first ends 51, 51′ of the two third magnetic induction elements 50, 50′ are disposed respectively at the upper part 331 and the lower part 333 of the second side part 33 of the coil 30. Wherein, the length of the two third magnetic induction elements 50, 50′ is the same as the width of the second magnet 23. In other words, the second ends 53, 53′ of the two third magnetic induction elements 50, 50′ are aligned to the end of the S pole 231 of the second magnet 23. The width of the two third magnetic induction elements 50, 50′ is less than the length of the second magnet 23. Preferably, the first ends 51, 51′ of the two third magnetic induction elements 50, 50′ are disposed respectively at the center of the upper part 331 and the center of the lower part 333 of the second side part 33 of the coil 30. Wherein, the two second magnetic induction elements 40, 40′ and the two third magnetic induction elements 50, 50′ are cuboids of the same size. In other words, the two second magnetic induction elements 40, 40′ and the two third magnetic induction elements 50, 50′ have the same length, width and height (i.e., thickness). In other embodiments, it is also allowable that the length of the two third magnetic induction elements 50, 50′ is the same as the width of the second magnet 23, and the width of the two third magnetic induction elements 50, 50′ is the same as the length of the second magnet 23. In other embodiments, the resettable dual diamagnetic linear resonant actuator may also comprise only one third magnetic induction element 50.

The inner sliding track set 60 comprises at least two base bodies 61 and a plurality of magnetic roller-balls 63. The two base bodies 61 are disposed respectively at the first magnet 21 and the second magnet 23, and respectively form a plurality of inner side tracks 611. The magnetic roller-balls 63 are movably disposed at the plurality of inner side tracks 611. The outer sliding track set 70 comprises two outer side tracks 71, 73. The coil 30 is fixed to the two outer side tracks 71, 73, and the magnetic roller-balls 63 respectively contact the two outer side tracks 71, 73. In the present embodiment, each base body 61 includes a top wall 613, a bottom wall 615, a connection wall 617 and four inner side tracks 611. The connection wall 617 connects the top wall 613 and the bottom wall 615, and forms a clamping space 619 with the top wall 613 and the bottom wall 615. The first magnet 21 and the second magnet 23 are clamped respectively by the two base bodies 61 in the respective clamping spaces 619, wherein the two inner side tracks are disposed on two sides of the top wall 613 and defined as the two upper inner tracks 6111, and the remaining two inner side tracks are disposed on the two sides of the bottom wall 615 and defined as the two lower inner tracks 6113. Wherein, each upper inner track 6111 includes an upper connection portion 61111, an upper bending portion 61113 and an upper extension portion 61115. The plurality of upper connection portions 61111 is connected to the two sides of the top wall 613 of the two base bodies 61 and extends upwards; the plurality of upper bending portions 61113 is connected to the upper connection portions 61111 and the upper extension portions 61115; and the plurality of upper extension portions 61115 extends laterally downwards, and an upper ball trench 61117 is disposed in a concave manner at the end of each upper extension portion 61115. Each lower inner track 6113 includes a lower connection portion 61131, a lower bending portion 61133 and a lower extension portion 61135. The plurality of lower connection portions 61131 is connected to the two sides of the bottom wall 615 of the two base bodies 61 and extends downwards; the plurality of lower bending portions 61133 is connected to the lower connection portions 61131 and the lower extension portions 61135; and the plurality of lower extension portions 61135 extends laterally upwards; a lower ball trench 61137 is disposed in a concave manner at the end of each lower extension portion 61135. The inner sliding track set 60 includes eight magnetic roller-balls 63, and the eight magnetic roller-balls 63 are roll-ably disposed respectively on the four upper inner tracks 61117 and the four lower inner tracks 61137.

A side of the upper ball trench 61117 facing the two outer side tracks 71, 73 forms respectively an upper opening, and a side of the lower ball trench 61137 facing the two outer side tracks 71, 73 forms respectively a lower opening. The plurality of magnetic roller-balls 63 protrudes beyond the upper and the lower openings. The length direction of the upper and lower ball trenches 61117, 61137 is parallel to the length direction of the two outer side tracks 71, 73. Each of the upper and lower ball trenches 61117, 61137 includes two stop walls 61119, 61139. The two stop walls 61119, 61139 of the upper and lower ball trenches 61117, 61137 protrude from the bottom wall of the upper and lower ball trenches 61117, 61137, and the magnetic roller-balls 63 are located between the two stop walls 61119, 61139 of the upper and lower ball trenches 61117, 61137. In the present embodiment, the two stop walls 61119, 61139 of the upper and lower ball trenches 61117, 61137 are located at the two ends along the length direction of the upper and lower ball trenches 61117, 61137. Preferably, the distance between the two stop walls 61119, 61139 of the upper and lower ball trenches 61117, 61137 is greater than the diameter of the magnetic roller-balls 63. The connection between the inner wall and the bottom wall of the upper and lower ball trenches 61117, 61137 has an arc-shaped surface. Wherein, the bottom of the magnetic roller-balls 63 disposed on the upper ball trenches 61117 is at a lower level than the top of the first and the second magnets 21, 23; and the top of the magnetic roller-balls 63 disposed on the lower ball trenches 61137 is at a higher level than the bottom of the first and the second magnets 21, 23. Wherein, the first magnetic induction element 10, the magnet set 20 and the inner sliding track set 60 form a movable part. The coil 30, the second magnetic induction elements 40, 40′, the third magnetic induction elements 50, 50′, and the outer sliding track set 70 form a fixed part.

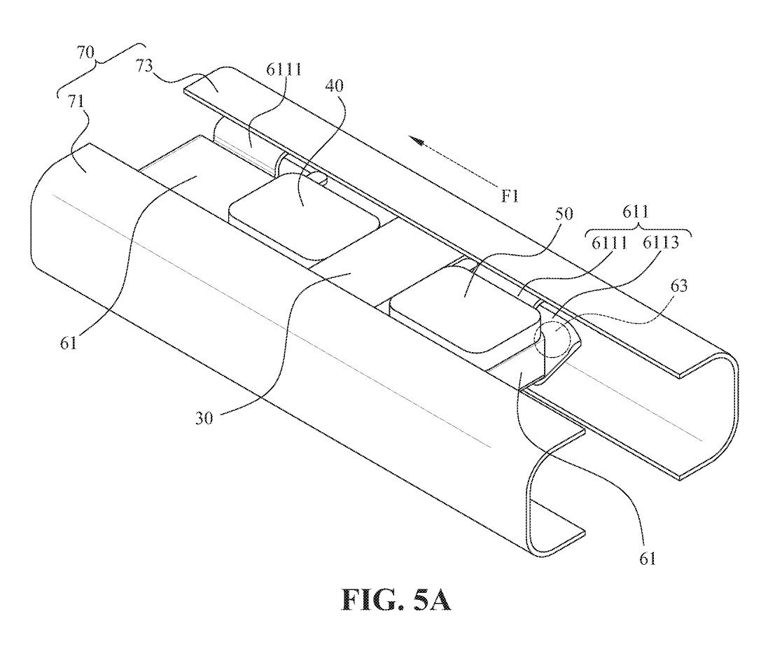

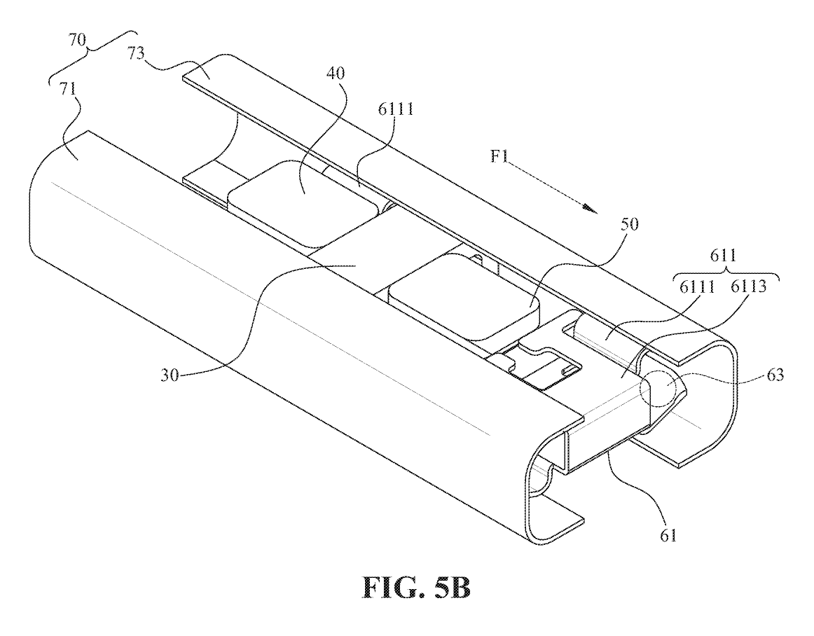

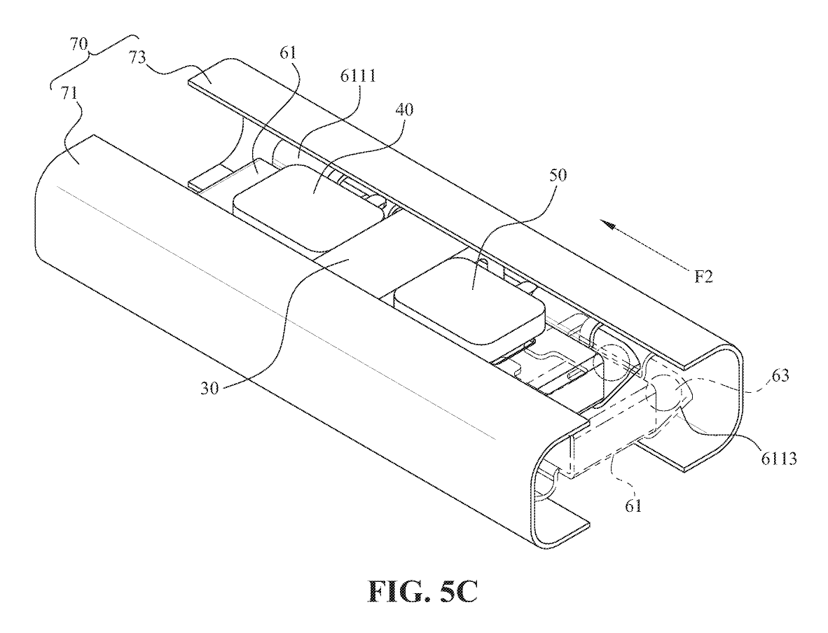

Refer to FIGS. 4, 5A and 5B. FIG. 4 shows a schematic view of the magnetic line distribution of the dual diamagnetic linear resonant actuator with magnetic roller-balls in accordance with an exemplary embodiment; FIG. 5A shows a dissected view of the movable part of the dual diamagnetic linear resonant actuator with magnetic roller-balls moving towards left with respect to the fixed part in accordance with an exemplary embodiment; and FIG. 5B shows a dissected view of the movable part of the dual diamagnetic linear resonant actuator with magnetic roller-balls moving towards right with respect to the fixed part in accordance with an exemplary embodiment. When the electricity runs through coil 30 continuously in alternating directions, the current through the coil 30 interacts with the magnetic field coming out of the magnet set 20 to generate Lorentz force F1. As such, the movable part can move to left and right with respect to the fixed part in a simple harmonic motion manner, as shown in FIGS. 5A and 5B. During the simple harmonic motion of the movable part with respect to the fixed part, the magnetic roller-balls 63 are affected by the friction of the two outer side tracks 71, 73 to roll on the upper and lower ball trenches 61117, 61137. When the frequency of the simple harmonic motion reaches the resonance state of the present invention, the present invention will reach the maximum resonant state.

FIG. 5C shows a schematic view of the dual diamagnetic linear resonant actuator with magnetic roller-ball, after the electricity is cut off from the coil, the movable part returning to original position by the pushing force of the magnetic restoration force in accordance with an exemplary embodiment. Wherein, when the movable part executes simple harmonic motion with respect to the fixed part, a magnetic restoration force F2 is generated between the first and the second magnets 21, 23, and the second and the third magnetic induction elements 40, 40′, 50, 50′. In general, the Lorentz force F1 is greater than the magnetic restoration force F2. Hence, when the electricity passes through the coil 30 continuously in alternating directions, the movable part is affected by the Lorentz force F1 to execute simple harmonic motion with respect to the fixed part. When the electricity is cut off from the coil 30, the Lorentz force F1 disappears immediately, and the movable part is no longer affected by the Lorentz force F1. As such, the magnetic restoration force F2 can immediately push the movable part to the original position so that the coil 30 once again surrounds the first magnetic induction element 10, the third magnet 25 and the fourth magnet 27. During the movable part returning to the original position, the magnetic roller-balls 63 are affected by the friction of the two outer side tracks 71, 73 to roll on the upper and lower ball trenches 61117, 61137.

In the dual diamagnetic linear resonant actuator with magnetic roller-ball of the present invention, the N poles 213, 233 of the first and the second magnets 21, 23 press respectively against the first side 13 and the second side 14 of the first magnetic induction element 10, the S poles 251, 271 of the third and fourth magnets 25, 27 press respectively against the third side 15 and the fourth side 16 of the first magnetic induction element 10, the coil 30 surrounds the first magnetic induction element 10, the third magnet 25 and the fourth magnet 27, and maintains a distance from the first end 11, the second end 12 of the first magnetic induction element 10 and from the N poles 253, 273 of the third and the fourth magnets 25, 27. As such, the first and the second magnets 21, 23 will compress the lines of magnetic force, and the third and fourth magnets 25, 27 will strengthen the magnetic force and guide the lines of magnetic force towards the coil 30 to achieve concentrating the density of the magnetic field and guiding the magnetic field towards the coil 30 to avoid divergence of lines of magnetic force and improve utilization efficiency of the magnetic field.

Moreover, the magnetic roller-balls 63 have high magnetic induction rate. According to the orientation of the magnetic lines, the centers of the magnetic roller-balls 63 are aligned with the ends of the S poles 211, 231 of the first magnet 21 and the second magnet 23. As such, when the movable part is driven by either the Lorentz force F1 or the magnetic restoration force F2 to move, the proper friction force is provided by the magnetic roller-balls 63 with the upper and lower ball trench 61117, 61137 and the two outer side tracks 71, 73 so as to improve the steady state response efficiency of the movable part and further improve the touch and resonance as well as improve lifespan and reduce the noise.

Furthermore, the two stop walls 61119, 61139 of the upper and lower ball trenches 61117, 61137 can prevent the magnetic roller-balls 63 from disengaging from the upper and lower ball trenches 61117, 61137.

Also, the length of the two stop walls 61119, 61139 of the upper and lower ball trenches 61117, 61137 is greater than the diameter of the magnetic roller-balls 63. As such, when the magnetic roller-ball 63 roll, no friction occurs between the magnetic roller-balls 63 and the two stop walls 61119, 61139 of the upper and lower ball trenches 61117, 61137, so as to further improve the steady state response efficiency of the movable part.

Also, as the connection between the inner wall and the bottom wall of the upper and lower ball trenches 61117, 61137 has an arc-shape, the magnetic roller-ball 63 can smoothly contact the inner wall of the upper and lower ball trenches 61117, 61137 to further improve the steady state response efficiency of the movable part.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A dual diamagnetic linear resonance actuator with magnetic roller-balls, comprising:
a first magnetic induction element, having a first end, a second end, a first side, a second side, a third side and a fourth side, wherein the first side and the second side being opposite to each other, while the third side and the fourth side being opposite to each other;
a magnet set, fluffier comprising a first magnet, a second magnet, a third magnet, and a fourth magnet; wherein the first magnet having an S pole and an N pole; the N pole of the first magnet pressing against the first side of the first magnet induction element; the second magnet having an S pole and an N pole; the N pole of the second magnet pressing against the second side of the first magnet induction element; the third magnet having an S pole and an N pole; the S pole of the third magnet pressing against the third side of the first magnet induction element; the fourth magnet having an S pole and an N pole; the S pole of the fourth magnet pressing against the fourth side of the first magnet induction element;
a coil, surrounding the first magnetic induction element, the third magnet and the fourth magnet, and respectively maintaining a distance from the first end and the second end of the first magnetic induction element, and from the N pole of the third magnet and the N pole of the fourth magnet;
an inner sliding track, comprising two base bodies and a plurality of magnetic roller-balls, the two base bodies being disposed respectively at the first magnet and the second magnet, and forming respectively a plurality of inner side tracks; the plurality of magnetic roller-balls being roll-ably disposed on the plurality of inner side tracks, and the center of the balls being aligned with the S poles of the first and the second magnets; and
an outer sliding track set, comprising two outer side tracks, the coil being fixed to the two outer side tracks, and the plurality of magnetic roller-balls contacting respectively the two outer side tracks.

2. The dual diamagnetic linear resonance actuator with magnetic roller-balls as claimed in claim 1, wherein each base body includes a top wall, a bottom wall, a connection wall and four inner side tracks; the connection wall connects the top wall and the bottom wall, and forms a clamping space with the top wall and the bottom wall; the first magnet and the second magnet are clamped respectively by the two base bodies in the respective clamping spaces, wherein the two inner side tracks are disposed on two sides of the top wall and defined as the two upper inner tracks, and the remaining two inner side tracks are disposed on the two sides of the bottom wall and defined as the two lower inner tracks; the inner sliding track set comprises eight magnetic roller-balls, and the eight magnetic roller-halls are disposed respectively on the four upper inner tracks and the four lower inner tracks.

3. The dual diamagnetic linear resonance actuator with magnetic roller-halls as claimed in claim 2, wherein the upper inner tracks forms respectively an upper ball trench, and the lower inner tracks form respectively a lower ball trench; a side of the upper ball trench facing the two outer sliding tracks forms respectively an upper opening, and a side of the lower ball trench facing the two outer side tracks forms respectively a lower opening; the plurality of magnetic roller-balls is roll-ably disposed on the upper and the lower ball trenches and protrudes beyond the upper and the lower openings.

4. The dual diamagnetic linear resonance actuator with magnetic roller-balls as claimed in claim 3, wherein the length direction of the upper and lower ball trenches is parallel to the length direction of the two outer side tracks; each of the upper and lower ball trenches includes two stop walls; the two stop walls of the upper and lower ball trenches protrude from the bottom wall of the upper and lower ball trenches, and the magnetic roller-balls are located between the two stop walls of the upper and lower ball trenches.

5. The dual diamagnetic linear resonance actuator with magnetic roller-balls as claimed in claim 4, wherein the two stop walls of the upper and lower ball trenches are located at the two ends along the length direction of the upper and lower ball trenches.

6. The dual diamagnetic linear resonance actuator with magnetic roller-balls as claimed in claim 4, wherein the distance between the two stop walls of the upper and lower ball trenches is greater than the diameter of the magnetic roller-balls.

7. The dual diamagnetic linear resonance actuator with magnetic roller-balls as claimed in claim 3, wherein the connection between the inner wall and the bottom wall of the upper and lower ball trenches has an arc-shaped surface.

8. The dual diamagnetic linear resonance actuator with magnetic roller-balls as claimed in claim 3, wherein the bottom of the magnetic roller-balls disposed on the upper ball trenches is at a lower level than the top of the first and the second magnets; and the top of the magnetic roller-balls disposed on the lower ball trenches is at a higher level than the bottom of the first and the second magnets.

9. The dual diamagnetic linear resonance actuator with magnetic roller-balls as claimed in claim 3, wherein each upper inner track comprises an upper connection portion, an upper bending portion and an upper extension portion; the plurality of upper connection portions is connected to the two sides of the top wall of the two base bodies and extends upwards; the plurality of upper bending portions is connected to the upper connection portions and the upper extension portions; and the plurality of upper extension portions extends laterally downwards; the plurality of upper ball trenches are disposed in a concave manner at the end of the plurality of upper extension portions;
wherein each lower inner track includes a lower connection portion, a lower bending portion and a lower extension portion, the plurality of lower connection portions is connected to the two sides of the bottom wall of the two base bodies and extends downwards; the plurality of lower bending portions is connected to the lower connection portions and the lower extension portions; and the plurality of lower extension portions extends laterally upwards; the plurality of lower ball trenches are disposed in a concave manner at the end of the plurality of lower extension portions.

10. The dual diamagnetic linear resonance actuator with magnetic roller-balls as claimed in claim 1, further comprising two second magnetic induction elements and two third magnetic induction elements, the two second magnetic induction elements are disposed at the coil, located respectively above and below the first magnet, and maintain a distance from the first magnet respectively; the two third magnetic induction elements are disposed at the coil, located respectively above and below the second magnet, and maintain a distance from the second magnet respectively; wherein the two ends of the two second magnetic induction elements along the length direction are defined as a first end and a second end, the second ends of the two second magnetic induction elements are aligned with the end of the S pole of the first magnet; the two ends of the two third magnetic induction elements along the length direction are defined as a first end and a second end, and the second ends of the two third magnetic induction elements are aligned with the end of the S pole of the second magnet.
